(19) United States
(12) Patent Application Publication
(10) Pub. No.: US 2018/0150863 A1
(43) Pub. Date: May 31, 2018

(54) Systems and Methods for Promoting Consumer Interaction With Merchants, Through Merchant Affiliates

(71) Applicant: MASTERCARD INTERNATIONAL INCORPORATED, Purchase, NY (US)

(72) Inventors: Rick Unnerstall, O'Fallon, MO (US); Brian Williams, St. Peters, MO (US); Corey M. Hively, O'Fallon, MO (US); Linda M. Mautz, O'Fallon, MO (US); Mahesh Nagure, O'Fallon, MO (US)

(21) Appl. No.: 15/364,593

(22) Filed: Nov. 30, 2016

(51) Int. Cl. G06Q 30/02; G06Q 20/38

(52) U.S. Cl. CPC G06Q 30/0222; G06Q 20/387; G06Q 30/0269

(57) ABSTRACT

Systems and methods are provided for promoting consumer interactions with merchants. One exemplary method includes associating a reference biometric to a merchant where the reference biometric is representative of a merchant affiliate associated with the merchant, and storing the reference biometric in a data structure as part of a merchant profile for the merchant. The method also includes receiving, at a computing device, a request from a communication device associated with a consumer where the request involves the merchant and includes a biometric captured by the communication device, and searching in the data structure, by the computing device, for the biometric included in the request. The method further includes, when the biometric included in the request matches the reference biometric representative of the merchant affiliate, responding to the request, by the computing device, with an incentive for purchase of at least one product at the merchant.

### FIELD

The present disclosure generally relates to systems and methods for use in promoting interaction between consumers and merchants and, in particular, to systems and methods for use in matching biometrics for merchant affiliates associated with the merchants, to thereby permit the consumers to authenticate (or verify or confirm) the merchant affiliates and then pursue incentives and/or support requests associated therewith.

### BACKGROUND

This section provides background information related to the present disclosure which is not necessarily prior art.

Consumers are known to use payment accounts to purchase various different products (e.g., good and services, etc.) from merchants. The merchants may be situated at different locations, including permanent physical locations (e.g., at brick-and-mortar locations, etc.), temporary physical locations (e.g., at kiosks, etc.), and/or virtual locations (e.g., websites, etc.). In any case, in order to purchase products from the merchants, the consumers often go to the particular locations of the merchants. Apart from the merchants and their locations, however, the consumers are known to interact with different individuals with regard to various products, for example, to solicit recommendations, acquire knowledge, troubleshoot problems, etc. Such interactions often involve individuals who already own the products and/or who are familiar with the products. As an example, a consumer may ask a host of a party, apart from any merchant location, how he/she likes a particular television in his/her living room, or whether he/she has had any problems with the television, or about his/her experience in purchasing the television from a specific merchant. In another example, the consumer may complain to another individual about an issue he/she is having with a particular product and/or an inability to properly configure a product.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in promoting interaction between a consumer and a merchant based on biometric authentication/verification of an affiliate associated with the merchant;

FIG. 2 is a block diagram of a computing device that may be used in the exemplary system of FIG. 1; and

FIG. 3 is an exemplary method, which may be implemented in the system of FIG. 1, for promoting the interaction between the consumer and the merchant.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Products (e.g., goods and/or services, etc.) are often purchased by consumers from merchants, in purchase transactions, through use of payment accounts. However, prior to making such purchases, the consumers may survey one or more people to determine what to buy, or what not to buy. In addition, after making such purchases, the same consumers may interact with other people to complain about the products purchased and/or to discuss problems with the same. These interactions may include information important to the merchants regarding the products and/or may provide scenarios through which the merchants can potentially influence future purchases by the consumers.

Uniquely, the systems and methods herein facilitate interactions between the consumers and merchant affiliates associated with the merchants, at settings apart from the merchant locations (e.g., at social gatherings, at other physical locations, via email, via support calls, via websites, etc.). In so doing, the interactions between the consumers and the merchants, by way of the merchant affiliates, may be more informal, more readily available, and/or more convenient. This may lead to increased satisfaction by the consumers with the merchants and/or improved merchant loyalty. For example, when a consumer happens across a merchant affiliate associated with a merchant, the consumer may desire to interact with the merchant affiliate regarding a product associated with the merchant. In so doing, the consumer initially captures a biometric (e.g., a facial image, a fingerprint, etc.) from the merchant affiliate and submits it to an affiliate engine, which in turn compares the biometric to a reference biometric (or multiple reference biometrics) for the merchant affiliate (to confirm that the merchant affiliate is actually associated with the merchant). When a match is found, the affiliate engine authenticates the merchant affiliate to the consumer and returns incentives and/or support to the consumer, directly (e.g., via a computing device associated with the consumer, etc.) or via the merchant affiliate. In this manner, the merchant is able to create a presence for the consumer apart from the merchant's actual location(s), through the merchant affiliate, to incentive the consumer to purchase a product from the merchant and/or to address potential support issues for a product previously purchased by the consumer from the merchant.

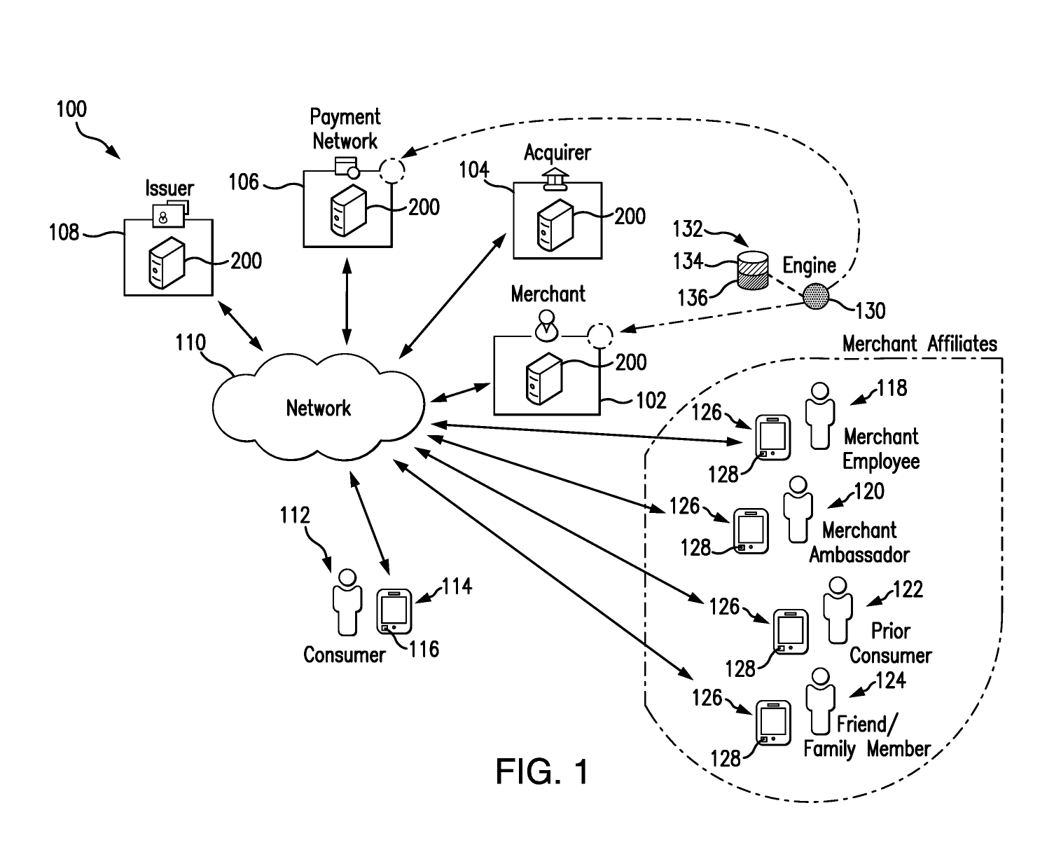

FIG. 1 illustrates an exemplary system 100, in which the one or more aspects of the present disclosure may be implemented. Although the system 100 is presented in one arrangement, other embodiments may include the parts of the system (or other parts) arranged otherwise depending on, for example, entities involved in processing purchase transactions to consumer payment accounts, interactions between consumers and merchants (and merchant affiliates), manners of purchasing products by consumers, etc.

As shown in FIG. 1, the system 100 generally includes a merchant 102, an acquirer 104 associated with the merchant 102, a payment network 106, and an issuer 108 of payment accounts, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may provide interconnection between the merchant 102, the payment network 106, the issuer 108 and/or a consumer 112 (specifically, a communication device 114 associated with the consumer 112 and comprising application 116), etc.

The merchant 102 is generally associated with products (e.g., goods and/or services, etc.) offered for sale to consumers (e.g., the consumer 112, etc.). It should be appreciated that the merchant 102 may include any desired type of merchant, and that various types of merchants, large or small, single store or multi-store, permanent, mobile, temporary, and/or virtual (e.g., with network-based store fronts, etc.) are within the scope of the present disclosure. For example, in one embodiment, the merchant 102 includes a kiosk disposed at a temporary location such as, for example, a shopping center. In another embodiment, the merchant 102 includes a virtual store front accessible via a website (e.g., via network 110, etc.). In still another embodiment, the merchant 102 includes a department store permanently located at a brick-and-mortar building.

Regardless of the type and/or size, etc. of the merchant 102, the merchant 102 is generally associated with one or more merchant affiliates 118-124. In this exemplary embodiment, the merchant 102 is associated with four merchant affiliates 118-124, but could be associated with any other number of affiliates within the scope of the present disclosure. The merchant affiliate 118, in this example, is a merchant employee, and the merchant affiliate 120, in this example, is a merchant ambassador. More specifically, the merchant affiliate 118 is employed by the merchant 102 to perform various tasks on behalf of the merchant 102 (e.g., as defined by a job description, etc.) generally beyond the operations described herein (i.e., as a conventional merchant employee), while the merchant affiliate 120 is associated with the merchant 102 but not so obligated to perform such additional tasks. Each of the merchant affiliates 118 and 120 may receive compensation in one form or another from the merchant 102. The merchant affiliate 122, in this example, is a consumer who was previously involved in a transaction with the merchant 102 (broadly, a prior consumer). And, the merchant affiliate 124, in this example, is a friend and/or family member of the consumer 112. It should be appreciated that, generally in this example, merchant affiliates will be one of the above, mutually-exclusive types of affiliates.

Each of the merchant affiliates 118-124 is associated with a communication device 126. And, each communication device 126, in this embodiment, is generally a portable communication device such as, for example, a tablet, a smartphone, a laptop, or another communication device, etc. As shown, each communication device 126 includes an application 128, which is installed and active in the communication device 126 to thereby configure the communication device 126 (e.g., via computer-executable instructions, etc.) to operate as described herein. With that said, when the communication device 126 is described as configured to perform various operations herein, it should be appreciated that it may be doing so generally in coordination with the application 128 (even if the application 128 is not specifically referenced), or not.

Further, as shown in FIG. 1, the consumer 112 is associated with the communication device 114, which may include, for example, a tablet, a smartphone, a laptop, or another communication device, etc. The communication device 114 is also generally, in this embodiment, a portable communication device. As shown, the communication device 114 includes the application 116, which is installed and active in the communication device 114 to thereby configure the communication device 114 (e.g., via computer-executable instructions, etc.) to operate as described herein. In various embodiments, the application 116 may include a payment application such as, for example, a virtual wallet (e.g., MasterPass®, Apple Pay®, Samsung Pay®, PayPal®, Google Wallet®, Android Wallet™, etc.), etc. Alternatively, the application 116 may be separate from any payment application, but still interact therewith, or not. With that said, when the communication device 114 is described as configured to perform various operations herein, it should be appreciated that it may be doing so generally in coordination with the application 116 (even if the application 116 is not specifically referenced), or not.

While one merchant 102, one acquirer 104, one payment network 106, one issuer 108, one consumer 112, and four merchant affiliates 118-124 are illustrated in FIG. 1, it should be appreciated that any number of these parts (and their associated parts, including third parties) may be included in the system 100, or may be included as one or more parts of systems in other embodiments, consistent with the present disclosure. In fact, often multiple ones or even hundreds of one or more of these parts may be included in system embodiments of the present disclosure.

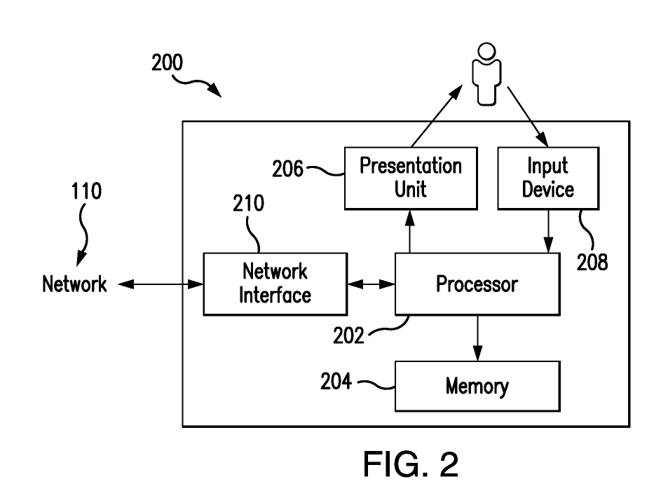

FIG. 2 illustrates an exemplary computing device 200 that can be used in the system 100. The computing device 200 may include, for example, one or more servers, workstations, personal computers, laptops, tablets, smartphones, PDAs, point-of-sale devices, etc. In addition, the computing device 200 may include a single computing device, or it may include multiple computing devices located in close proximity to or distributed over a geographic region, so long as the computing devices are specifically configured to function as described herein.

In the exemplary embodiment of FIG. 1, each of the merchant 102, the acquirer 104, the payment network 106, and the issuer 108 are illustrated as including, or being implemented in, computing device 200, coupled to the network 110. In addition, the communication devices 114 and 126, which are associated with the consumer 112 and the affiliates 118-124, respectively, can also be considered a computing device consistent with computing device 200 for purposes of the description herein. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, merchant profiles, consumer profiles, payment account credentials, merchant affiliate content (e.g., biometric data, incentive packages, support packages, etc.), support tickets, interfaces, transaction data, and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the operations described herein.

In the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., discounts, purchase options, support forms, merchant affiliate authentications, etc.), visually, for example, to a user of the computing device 200 such as to the consumer 112 and/or one or more of the affiliates 118-124 in the system 100, etc. It should be further appreciated that various interfaces (e.g., as defined by network-based applications, websites, etc.) may be displayed at computing device 200, and in particular at the presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user of the computing device 200 (i.e., as user inputs) such as, for example, a captured biometric from the consumer 112 for one (or more) of the merchant affiliates 118-124, etc. The input device 208 is coupled to (and is in communication with) the processor 202 and may include, for example, a keyboard, a pointing device, a mouse, a stylus, a camera, a fingerprint scanner, a retina scanner, a palm scanner, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the system 100 also includes an affiliate engine 130, and a data structure 132 coupled to (and in communication with) the affiliate engine 130. The affiliate engine 130 is specifically configured, by executable instructions, to perform one or more of the operations herein. The affiliate engine 130 is illustrated in the system 100 as a standalone part and, as such, may be implemented in and/or associated with a computing device consistent with computing device 200. However, as indicated by the dotted lines, the affiliate engine 130 (along with the data structure 132, or not) may be incorporated, at least in part, with either the merchant 102 or the payment network 106 (e.g., in association with the computing devices 200 associated therewith, etc.). In addition, in still other embodiments, the affiliate engine 130 may be incorporated, at least partly, elsewhere in the system 100 (e.g., in other parts of the system 100, etc.), or in other entities not shown.

In this exemplary embodiment, the data structure 132 includes two separate data structures: a merchant data structure 134 and a consumer data structure 136. In connection therewith, the data structure 132 (including the merchant data structure 134 and/or the consumer data structure 136) may be stored in memory (e.g., memory 204, etc.) in association with the affiliate engine 130, as indicated by the dotted line in FIG. 1. However, in other embodiments, the data structure 132 may be stored in memory apart from the affiliate engine 130.

Generally in the system 100, the affiliate engine 130 is configured to register the merchant 102, and other merchants (not shown) in the system 100, for affiliate services as described herein. In particular, when the merchant 102 desires to take on the affiliates 118-124 (e.g., hire the affiliate 118 as an employee, be associated with the affiliates 120-124, etc.), the merchant 102 submits a request to the affiliate engine 130 for such registration. In response, the affiliate engine 130 is configured to solicit merchant affiliate content relating to the merchant 102 and to the affiliates 118-124. Such content may include, for example, biometric data (e.g., reference biometrics, etc.) for the affiliates 118-124, incentive packages associated with the merchant 102, support packages associated with the merchant 102, etc. With that said, the biometric data may include, without limitation, facial images, fingerprints, palm prints, retina images, voice recordings, etc. The incentive packages may include, without limitation, coupons (e.g., discounts, rebates, etc.) that the affiliates 118-124 may disseminate to the consumer 112 and other potential consumers, dynamic pricing options, compensation schedules for the affiliates 118-124 (e.g., commissions, discounts, rebates, etc.), etc. And, the support packages may include, without limitation, support instructions, directories, interfaces, etc. that may be disseminated by the affiliate engine 130 to the affiliates 118-124 and/or to the consumer 112.

Once the merchant affiliate content is received from the merchant 102, in connection with the registration, the affiliate engine 130 is configured to then store the merchant affiliate content in the data structure 132 and, in particular, in the merchant data structure 134 thereof. In connection therewith, the merchant data structure 134 includes a profile for the merchant 102 (and profiles for various other merchants that may desire to use features of the present disclosure), with which the affiliate engine 130 associates the merchant affiliate content (e.g., for subsequent identification, editing, etc.).

Table 1 illustrates example merchant affiliate content for the merchant 102, as may be included in a profile for the merchant 102 in the merchant data structure 134 (as part of data structure 132). In this example, the merchant 102 is registered to the affiliate engine 130, with the four affiliates 118-124. As such, the merchant data structure 134 includes at least one reference biometric for each of the merchant affiliates 118-124. In addition, the merchant data structure 134 includes incentive packages and support packages for each of the affiliates 118-124. The incentive packages identify a number (and type) of coupons, for use at the merchant 102, available to the affiliates 118-124 to distribute to consumers (e.g., to the consumer 112, etc.), and a compensation schedule for the affiliates 118-124. And, the support packages identify the types of support available to the affiliates 118-124, when needed.

TABLE 1

| | Merchant | Merchant | Merchant | Merchant |
|---|---|---|---|---|
| | Affiliate 118 | Affiliate 120 | Affiliate 122 | Affiliate 124 |
| Type | Merchant | Merchant | Prior Consumer | Friend/Family |
| | Employee | Ambassador | | Member |
| Coupons | 12-10% off 1 | 20-5% off 1 | 2-10% off 1 | 5-5% off 1 item |
| | item | item | item | |
| | 6-25% off 1 | 3-10% off 1 | 3-buy one get | |
| | item | item | one | |
| | 2-5% entire | | | |
| | purchase | | | |
| Compensation | $3 for each | $2 for each | 10% discount on | 10% discount on |
| | redeemed coupon | redeemed coupon | 1 item for 5 | 1 item for 5 |
| | -or- | -or- | coupons | coupons |
| | 0.75% sales | 1.1% sales | redeemed | redeemed |
| | commission | commission | -and- | -and- |
| | -and- | | 15% coupon for | 15% coupon for |
| | $1.00 for support | | each new affiliate | each new affiliate |
| | resolution | | | |
| Support | API form to | API form to | Phone number for | Phone number for |
| | communication | communication | express support | express support |
| | device | device | | |
| | | -and- | | |
| | | Support | | |
| | | instructions | | |
| | | and/or manual | | |

It should be appreciated that any type of merchant affiliate content may be included in the merchant data structure 134 (of the data structure 132) as part of the profile for the merchant 102, for a given one of the merchant affiliates 118-124 or group of such affiliates 118-124 (such that the data in Table 1 should not be considered limiting). For example, the incentive packages may include any number and/or type of coupons (e.g., discounts, rebates, etc.), compensations, etc. Similarly, the support packages may include any type of support, items relating to support, and/or support tools, etc. Further, the particular content included in the merchant data structure 134 may be dependent, for example, on a type of the merchant 102, quantities and/or costs associated with products available from the merchant 102, typical consumers for the merchant 102 (e.g., taking into account demographics, purchasing behavior, shopping behavior, etc.), the specific affiliates 118-124 (e.g., their demographics, their experience, their affiliate history, etc.), or any other characteristics of the merchant 102 and/or its typical consumers that may suggest and/or facilitate the provision of specific incentives and/or support, etc.

With continued reference to FIG. 1, the consumer data structure 136 of the data structure 132 includes a profile for the consumer 112 (and profiles for various other consumers that may desire to use features of the present disclosure to help authenticate the merchant affiliates 118-124 in connection with interactions therewith). In particular, when the consumer 112 installs and/or activates the application 116 at the communication device 114 (or at a later time), the consumer 112 registers to the affiliate engine 130. In so doing, the affiliate engine 130 is configured to solicit various information relating to the consumer 112, such as his/her name, mailing address, contact information (e.g., email address, phone number, etc.), application identifier, permissions, etc. through the application 116, or potentially through another computing device having access to the affiliate engine 130 (e.g., via a website, etc.). Upon receiving such information from the consumer 112, the affiliate engine 130 is configured to compile the profile for the consumer 112 (including an application identifier for the application 116, for example, at the consumer's communication device 114), and to store the consumer's profile in the consumer data structure 136. In addition, the affiliate engine 130 may be configured to solicit and/or retrieve transaction data associated with the consumer 112 (e.g., purchase histories, etc.), from the payment network 106 and/or the issuer 108 and/or other part of the system 100, for example, and store such data in the consumer data structure 136 in association with the consumer's profile.

In the embodiments herein, consumers (e.g., consumer 112, etc.) involved in the different transactions and/or interactions are prompted to agree to legal terms and/or provide certain permissions associated with their payment accounts and/or installed network-based applications, for example, during enrollment in their accounts and/or installation of such applications, etc. In so doing, the consumers voluntarily agree, for example, to allow merchants, issuers, payment networks, etc., to use transaction and/or location data generated and/or collected during enrollment, or later, and/or in connection with processing transactions, for subsequent use in general, and as described herein.

In an example application of the system 100, in various embodiments the merchant affiliate 118 may encounter the consumer 112 in a setting outside of a location of the merchant 102 (e.g., at a social function, etc.). As part of the interactions between the two, the consumer 112 may express some interest in a product offered for sale by the merchant 102 and/or dissatisfaction with a product previously purchased from the merchant 102. In response, the merchant affiliate 118 is tasked with addressing the consumer's need, and thereby informs the consumer 112 of his/her affiliation with the merchant 102 and invites the consumer 112 to utilize the application 116 to capture the affiliate's biometric. In turn, and upon input by the consumer 112, the consumer's communication device 114 is configured, via the application 116, to capture biometric data (e.g., a facial image, etc.) from the merchant affiliate 118 and to transmit the biometric data to the affiliate engine 130 as part of a request to authenticate the merchant affiliate 118 (e.g., as an incentive request, a support request, etc.), via the network 110. The affiliate engine 130 is configured to receive the request (including the biometric data) and search in the merchant data structure 134 for matching biometric data (e.g., for a matching reference biometric, etc.), to the biometric data received from the communication device 114. When a match is found (and the merchant affiliate 118 is authenticated), the affiliate engine 130 is configured to identify the merchant 102 associated with the merchant affiliate 118 and access the profile for the merchant 102. In connection therewith, the affiliate engine 130 is configured to also determine the incentives and/or support services assigned and/or associated with the merchant affiliate 118. Once determined, the affiliate engine 130 is configured to provide the incentives and/or support services (depending on the initial request) to the consumer's communication device 114 and/or to the merchant affiliate's communication device 126, as appropriate (e.g., potentially taking into account data in the consumer's profile, etc.).

As part of the interactions between the consumer 112 and the merchant affiliate 118 (outside of the location of the merchant 102), when the request received from the consumer 112 is an incentive request, for example, the affiliate engine 130 may be configured to return coupons to the communication device 126 associated with the merchant affiliate 118 (e.g., based on data included in the request such as product type, based on consumer information included in the consumer's profile, etc.), who is then able to transfer or otherwise provide the coupons (as desired) to the consumer 112. In various embodiments, the affiliate's communication device 126 may be configured to further offer (via the merchant affiliate 118), to the consumer 112, a particular product for sale from the merchant 102, whereupon a coupon returned from the affiliate engine 130 and/or selected by the merchant affiliate 118, for example, may be applied to the product. The consumer 112 may then employ a payment application (as part of the application 116, for example) at his/her communication device 114 to interact with the affiliate's communication device 126 to fund a purchase transaction for the product. The affiliate engine 130 is configured to record and track the merchant affiliate's distribution of the coupon to the consumer 112 and to further record and track the redemption of the coupon. The affiliate engine 130 is configured to then cause compensation, as defined in the incentive package for the merchant affiliate 118, to be provided to the merchant affiliate 118.

In an example purchase transaction for the product, as part of the above incentive request, the consumer 112 presents payment credentials (for a payment account issued to the consumer 112 by the issuer 108) to the merchant affiliate 118 (specifically, to the merchant affiliate's communication device 126), via the payment application at his/her communication device 114. Alternatively, the consumer 112 may present the payment credentials to the merchant affiliate 118 via another payment device (e.g., via a credit card, a debit card, a prepaid card, a fob, etc.). In either case, as is traditional, the merchant affiliate's communication device 126 (on behalf of the merchant 102) then transmits an authorization request for the transaction (comprising transaction data for the transaction) to the acquirer 104 (through the network 110). In turn, the acquirer 104 communicates the authorization request with the issuer 108 (again via the network 110) through the payment network 106 (e.g., through MasterCard®, VISA®, Discover®, American Express®, etc.). The issuer 108 determines whether the consumer's payment account is in good standing and whether there are sufficient funds and/or credit to fund the transaction. If approved, an authorization reply, or response (indicating the approval of the transaction), is transmitted back from the issuer 108 to the merchant 102 (and/or the merchant affiliate 118), thereby permitting the merchant 102 to complete the transaction. The transaction is later cleared and/or settled (via appropriate transaction messages such as clearing messages and/or settlement messages, for example) by and between the merchant 102, the acquirer 104, and the issuer 108 (by appropriate agreements).

Alternatively, when the request received from the consumer 112 is a service request, the affiliate engine 130 may be configured to provide an application programming interface (API) form to the consumer's communication device 114 and/or to the merchant affiliate's communication device 126. In response, the consumer 112 and/or the merchant affiliate 118 may enter information specific to the support request (e.g., product name, merchant name, brand name, model number, issue description, etc.), which is received by the affiliate engine 130. In turn, the affiliate engine 130 is configured to initiate a support ticket in an associated support entity (not shown) (e.g., a support customer-support division of the merchant 102, an independent entity configured to provide customer support for the product, etc.). The support ticket, when received from the affiliate engine 130, often will receive express treatment over other tickets. Additionally, or alternately, the affiliate engine 130 may be configured to issue instructions to the consumer's communication device 114 and/or to the merchant affiliate's communication device 126, to aid the merchant affiliate 118 in solving the issue of the consumer 112. In either event, the support request is tracked to resolution, by the affiliate engine 130, whereby (or prior) the affiliate engine 130 is configured to compensate the affiliate 118 for his/her aid to the consumer 112, again as defined in the incentive package for the merchant affiliate 118.

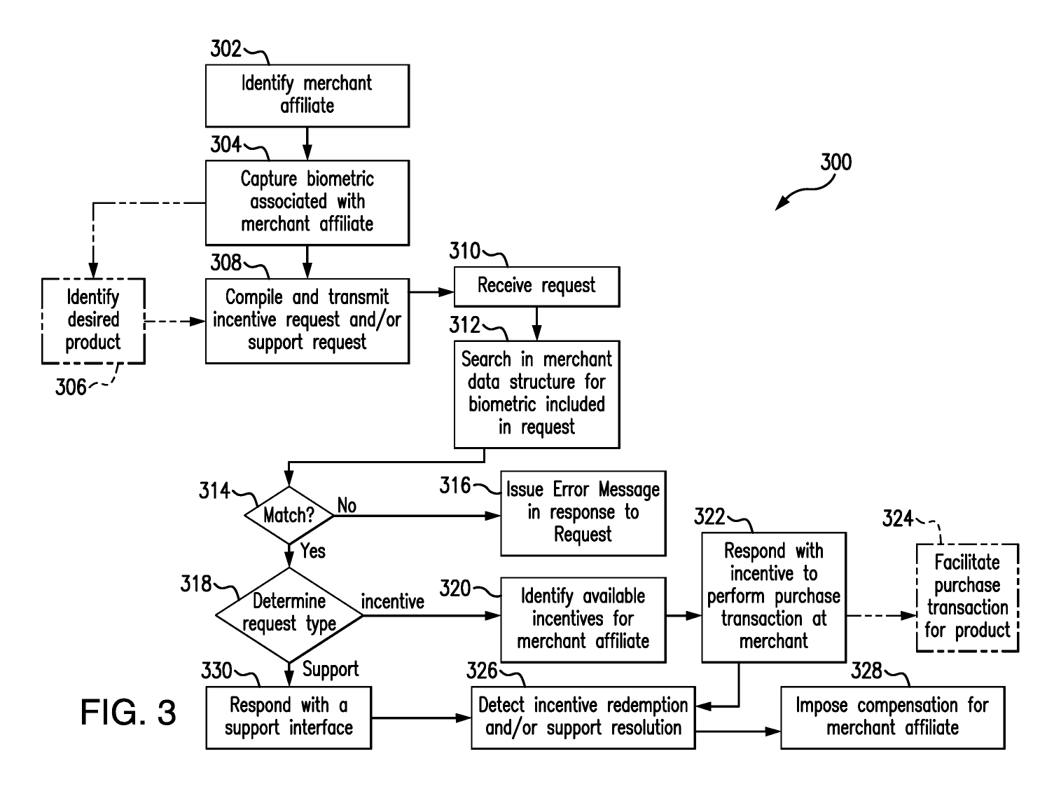

FIG. 3 illustrates an exemplary method 300 for promoting interactions between consumers and merchants, via merchant affiliates. The exemplary method 300 is described as implemented in the affiliate engine 130 of system 100, in association with the communication devices 114 and 126 and their corresponding applications 116 and 128. However, it should be understood that the method 300 is not limited to this configuration, as the method 300 may be implemented in other parts of the system 100. As such, the methods herein should not be understood to be limited to the exemplary system 100 or the exemplary computing device 200, and likewise, the systems and the computing devices herein should not be understood to be limited to the exemplary method 300.

In addition, the exemplary method 300 is described with reference to various example interactions between the consumer 112 and each of the merchant affiliates 118-124. It should be appreciated, however, that method 300 is not limited to these interactions, and may encompass other interactions between consumers and merchant affiliates.

In one example interaction, the consumer 112 may encounter the merchant affiliate 118 at a social event and interact therewith. As part of the interaction, the consumer 112 may express an interest to the merchant affiliate 118 in a particular product. In response, the merchant affiliate 118 explains that he/she is associated with the merchant 102, which offers the product for sale or offers a related product for sale (broadly, the product). In this way, the consumer 112 identifies the merchant affiliate 118, at 302, as being associated with the merchant 102. As part of this example interaction, the merchant affiliate 118 may also inform the consumer 112 that he/she can provide a discount or other incentive to the consumer 112 for the product, if the consumer 112 purchases the product from the merchant 102. Here, when the consumer 112 is interested in the discount or other incentive, he/she may wish to confirm and/or authenticate the merchant affiliate 118 (e.g., confirm that the merchant affiliate 118 is actually associated with the merchant 102 and authorized to offer the discount or other incentive, etc.).

To confirm that the merchant affiliate 118 is actually associated with the merchant 102, the consumer 112 utilizes the communication device 114 (and more particularly the application 116 therein) to capture a biometric of the merchant affiliate 118, at 304 (e.g., an image of the merchant affiliate's face, etc.). In addition to the biometric, the consumer 112 may optionally (as indicated by the dotted lines in FIG. 3) input to the communication device 114 (via the application 116) an identification of the particular product in which the consumer 112 is interested (e.g., a product name, brand of the product, and/or model of the product, etc.), at 306. Further, the consumer 112 may input any additional information associated with the example interaction, such as, for example, the name of the merchant 102 as identified by the merchant affiliate 118, etc. The communication device 114 then compiles an incentive request, in this example interaction, based on the input(s) from the consumer 112 and transmits the inventive request to the affiliate engine 130, at 308.

In turn, the affiliate engine 130 receives the incentive request, at 310, and searches in the data structure 132 for a matching reference biometric, at 312, based on the biometric included in the request. In particular in the exemplary method 300, the affiliate engine 130 accesses the merchant data structure 134 (of the data structure 132) and searches for the received/sample biometric. In so doing, the affiliate engine 130 compares, at 314, the received biometric to the various reference biometrics included in the merchant data structure 134.

The comparison of the received biometric to the reference biometrics included in the merchant data structure 134 may be done via any suitable algorithms, for example, depending on the particular biometric being compared (e.g., utilizing biometric feature extraction and template generation and comparison (where the templates represent the biometrics reduced to zeros and ones, as is generally known), etc.). What's more, the comparison may require an exact match, or the comparison may require a match within an acceptable confidence range (e.g., depending on the algorithm, depending on the particular biometric, etc.). In particular, for example, principal components analysis (PCA), linear discriminant analysis (LDA), elastic bunch graph matching (EBGM), independent component analysis (ICA), evolutionary pursuit (EP), kernel methods, the trance transform, an active appearance model (AAM), a 3-D morphable model, 3-D face recognition, the Bayesian framework, hidden Markov Models (HMMs), the GaussianFace face recognition algorithm, FaceNet, etc. may be used to compare facial images; minutiae-based matching, pattern matching, etc. may be used to compare fingerprints; IrisCode® comparison may be used to compare retina scans; minutiae-based matching, correlation-based matching, ridge-based matching, etc. may be used to compare palm prints; etc.

When a match is not found, at 314, the affiliate engine 130 issues an error message in response to the incentive request, at 316, and transmits the error message to the consumer's communication device 114. As such, the consumer 112 is informed that the merchant affiliate 118 is not associated with the merchant 102 (or, potentially, is associated with a different merchant). And, the consumer 112 may end the interaction with the merchant affiliate 118.

Conversely, if a matching biometric is found at 314 (in the merchant data structure 134), the affiliate engine 130 determines, at 318, whether the request is an incentive request or a support request (e.g., based on data included in the request representative of the consumer's inputs, etc.).

In connection therewith, if the request is an incentive request (as in this example interaction), the affiliate engine 130 identifies, at 320, available incentives for the merchant affiliate 118 (from the merchant data structure 134). As shown in Table 1, for example, the merchant affiliate 118 may be provided with 20 total different coupons that can be used at the merchant 102, ranging from a percentage off one item to a percentage off an entire purchase (the selection of which may then be based on consumer information in the consumer's profile). Again, it should be appreciated that any number of different incentives (e.g., rebates, discounts, dynamic pricing options, special offers, etc.) may be identified to the merchant affiliate 118 at 320. Then, upon identification of the incentives, the affiliate engine 130 responds with a selection of an incentive (or multiple incentives) as available from the merchant affiliate 118, at 322, to entice the consumer 112 to perform a purchase transaction at the merchant 102. The response may be directed to the communication device 114 associated with the consumer 112 (such that the consumer directly receives the incentives). Or alternatively, (or additionally), the response may be directed to the communication device 126 associated with the merchant affiliate 118, whereupon the merchant affiliate 118 is able to then select the specific incentive to provide to the consumer 112 (upon which it is assigned and/or delivered to the consumer 112), etc. Further, in various embodiments, the affiliate 118 may alternatively (or additionally) transmit the incentives to the consumer 112 at a mailing address associated with the consumer 112, an email address, etc. (e.g., as obtained from the application 116 at the consumer's communication device, as obtained from the consumer's profile in the consumer data structure 136, etc.). It should be appreciated that in some embodiments the affiliate engine 130 may identify incentives for the consumer 112 (e.g., at 322, etc.) independent of those potentially available to the merchant affiliate 118, for example, based on data in the consumer's profile (e.g., based on prior transaction data, etc.).

In connection with providing the incentives to the consumer 112 (be it directly or through the merchant affiliate 118), the consumer 112 is generally encouraged to shop at the merchant and, potentially, purchase a particular product from the merchant 102 (e.g., the product identified in the request (or a related product) if the request in fact includes such an identification, etc.). In particular, once received, the incentives are displayed to the consumer 112 at his/her communication device 114 in combination with a sales platform, for example, provided by the application 116. In this manner, the consumer 112 is able to view the incentives and, potentially, various products available for purchase from the merchant 102 using the incentives.

When the consumer 112 desires to use one or more of the incentives to purchase a product, he/she may select the product (and potentially the desired one or more incentives to be used) and manually provide payment account credentials to the sales platform (via the communication device 114). Or, the consumer 112 may use the communication device 114 (and in particular the payment application therein associated with the application 116, for example) to provide the payment account credentials. In either case, once submitted, the communication device 114 (via the application 116) transmits the product selection along with the consumer's payment account credentials to the affiliate engine 130. In turn, the affiliate engine 130, optionally (as indicated by the dotted lines in FIG. 3), facilitates a purchase transaction for the product, at 324, on behalf of the merchant 102 (in the manner generally described above in connection with the system 100). In so doing, the particular incentive(s) selected by the consumer 112 for use is redeemed. And, the purchased product may then be delivered to the consumer 112 (e.g., made available for consumer pick-up at the merchant 102, shipped to an address associated with the consumer 112, etc.). It should be appreciated that the consumer 112 may also (or alternatively) redeem the incentives with the merchant affiliate 118 (e.g., by selecting a product at the merchant affiliate's communication device 126, etc.), or directly with the merchant 102 (e.g., in a purchase transaction directly at the location of the merchant 102, at a virtual location of the merchant 102, etc.), as desired.

Subsequently, upon purchasing the product from the merchant 102, the affiliate engine 130 detects, at 326, the redemption of the incentive(s) and imposes the appropriate compensation for the merchant affiliate 118, at 328 (e.g., as shown in Table 1, as retrieved from the merchant data structure 134, etc.). To do so, depending on the form of the compensation, the affiliate engine 130 may assign the compensation to the merchant affiliate 118 and fund an account associated with the merchant affiliate 118 with the compensation, immediately or at one or more intervals. Alternatively, the affiliate engine 130 may cause the compensation to be physically delivered to the merchant affiliate 118 at an address associated therewith.

With continued reference to FIG. 3, in another example interaction involving the method 300, the merchant affiliate 120 may pitch a product for sale to the consumer 112, or to a group of consumers, at a location away from the merchant 102 (e.g., as a door-to-door affiliate, etc.). In so doing, the merchant affiliate 120 may interact with the consumer 112 at the consumer's residence. Upon such interaction, the merchant affiliate 120 may learn that the consumer 112 has already purchased the product form the merchant 102, but is having an issue with the product (e.g., the product continually resets, etc.). In turn, the merchant affiliate 120 informs the consumer 112 of his/her association with the merchant 102. In this way, the consumer 112 identifies the merchant affiliate 120, at 302, as being associated with the merchant 102. As part of this example interaction, the merchant affiliate 120 may also inform the consumer 112 that he/she is able to facilitate support for the consumer 112 for the product, to potentially help resolve the consumer's issue therewith.

To confirm that the merchant affiliate 120 is actually associated with the merchant 102, the consumer 112 utilizes the communication device 114 (and more particularly the application 116 therein) to capture a biometric of the merchant affiliate 120, at 304 (e.g., an image of the merchant affiliate's face, etc.). In addition to the biometric, the consumer 112 may optionally (as indicated by the dotted lines in FIG. 3) input to the computing device 114 (via the application 116) an identification of the particular product for which support is required (e.g., a product name, brand of the product, and/or model of the product, etc.), at 306. Further, the consumer 112 may input additional information associated with the example interaction, such as, for example, a description of the consumer's issue/problem with the product. The communication device 114 then compiles a support request, in this example interaction, based on the input(s) from the consumer 112 and transmits the support request to the affiliate engine 130, at 308.

In turn, the affiliate engine 130 receives the support request, at 310, and searches in the data structure 132 for a matching reference biometric, at 312, based on the biometric included in the request. In particular in the exemplary method 300, and as described above, the affiliate engine 130 accesses the merchant data structure 134 (of the data structure 132) and searches for the received/sample biometric. In so doing, the affiliate engine 130 compares, at 314, the received biometric to the various reference biometrics included in the merchant data structure 134 (e.g., via suitable algorithms, etc.). As above, when a match is not found, at 314, the affiliate engine 130 issues an error message in response to the incentive request, at 316, and transmits the error message to the consumer's communication device 114.

Conversely, if a matching biometric is found at 314 (in the merchant data structure 134), the affiliate engine 130 determines, at 318, whether the request is an incentive request or a support request (e.g., based on data included in the request representative of the consumer's inputs, etc.).

Because the request is a support request in this example interaction, the affiliate engine 130 responds, at 330, with a support interface. As shown in Table 1, for example, the merchant affiliate 120 is associated with (and is able to provide to the consumer 112) a support form that can be used by the consumer 112 to identify and potentially resolve his/her issue with the product. As such, the support interface provided by the affiliate engine 130, at 330, presents the support form to the merchant affiliate 120 at the communication device 126, and/or to the consumer 112 at communication device 114. Subsequently, the form is filled out by the merchant affiliate 120 and/or the consumer 112 (via input(s) to the corresponding communication devices 126 and 114), and transmitted to the affiliate engine 130 (again, via the corresponding communication devices 126 and 114). The affiliate engine 130, in turn, receives the form (or content therefrom) and generates and submits a consumer support ticket for the product to an appropriate support team and/or system (not shown). The support ticket, as based on the support request involving the merchant affiliate 120, may be given priority and/or special treatment, whereupon resolution of the consumer's issue may be achieved faster than through convention merchant support avenues (since it involved the merchant affiliate 120).

Additionally, or alternatively, the support interface provided by the affiliate engine 130 may include instructions for the consumer 112 and/or the merchant affiliate 120 to resolve of the issue with the product. Specifically, for example, when the support interface is returned to the communication device 126 associated with the merchant affiliate 120, the merchant affiliate 120 may then attempt to interact with the product and/or the consumer 112 to resolve the issue. And, the merchant affiliate 120 may indicate back to the affiliate engine 130, via the communication device 126, whether the issue was resolved or not. When the issue is still not resolved, the affiliate engine 130, like above, then generates and submits the consumer support ticket for the product to an appropriate support team and/or system (not shown).

Then in the method 300 (in this example interaction), upon issuance of the support ticket for the product by the affiliate engine 130 and/or an indication by the merchant affiliate 120 (or by the consumer 112) that the issue relating to the product is resolved (or otherwise), the affiliate engine 130 detects the support resolution, at 326, and, like above, imposes the appropriate corresponding compensation, at 328, for the merchant affiliate.

With further reference to FIG. 3, in yet another example interaction involving the method 300, the consumer 112 may be present at a social function hosted by the merchant affiliate 122 (or the merchant affiliate 124) at the affiliate's home, during which the consumer 112 notices a product on the wall in which the consumer is interested. In response to the interest, the merchant affiliate 122 informs the consumer 112 that he/she purchased the product from the merchant 102, and he/she is also associated with the merchant 102. In this way, the consumer 112 identifies the merchant affiliate 122, at 302, as being associated with the merchant 102. And, like above, as part of this example interaction, the merchant affiliate 122 may also inform the consumer 112 that he/she can provide a discount or other incentive to the consumer 112 for the product, if the consumer 112 purchases the product from the merchant 102. In response, the consumer 112 may wish to confirm and/or authenticate the merchant affiliate 122 (e.g., confirm that the merchant affiliate 122 is actually associated with the merchant 102 and authorized to offer the discount or other incentive, etc.).

To confirm that the merchant affiliate 122 is actually associated with the merchant 102, the consumer 112 utilizes the communication device 114 (and more particularly the application 116 therein) to capture a biometric of the merchant affiliate 122, at 304 (e.g., an image of the merchant affiliate's face, etc.). In addition to the biometric, the consumer 112 may optionally (as indicated by the dotted lines in FIG. 3) input to the computing device 114 (via the application 116) an identification of the particular product in which the consumer 112 is interested (e.g., a product name, brand of the product, and/or model of the product, etc.), at 306. For example, the consumer 112 may scan, via the communication device 114, a barcode, QR code, or other identifier present on the product, etc. Further, the consumer 112 may input any additional information associated with the example interaction, such as, for example, the name of the merchant 102 as identified by the merchant affiliate 122, etc. The communication device 114 then compiles an incentive request, in this example interaction, based on the input(s) from the consumer 112 and transmits the inventive request to the affiliate engine 130, at 308.

In turn, the affiliate engine 130 receives the incentive request, at 310, and searches in the data structure 132 for a matching reference biometric, at 312, based on the biometric included in the request. In particular in the exemplary method 300, the affiliate engine 130 accesses the merchant data structure 134 (of the data structure 132) and searches for the received/sample biometric. In so doing, the affiliate engine 130 compares, at 314, the received biometric to the various reference biometrics included in the merchant data structure 134 (e.g., via suitable algorithms, etc.). When a match is not found, at 314, the affiliate engine 130 issues an error message in response to the incentive request, at 316, and transmits the error message to the consumer's communication device 114. As such, the consumer 112 is informed that the merchant affiliate 122 is not associated with the merchant 102 (or, potentially, is associated with a different merchant). And, the consumer 112 may end the interaction with the merchant affiliate 122.

Conversely, if a matching biometric is found at 314 (in the merchant data structure 134), the affiliate engine 130 determines, at 318, whether the request is an incentive request or a support request (e.g., based on data included in the request representative of the consumer's inputs, etc.).

Because the request is an incentive request in this example interaction, the affiliate engine 130 identifies, at 320, available incentives for the merchant affiliate 122 (from the merchant data structure 134). As shown in Table 1, for example, the merchant affiliate 122 may be provided with five total different coupons that can be used at the merchant 102, ranging from a percentage off one item to a buy one get one free offer. Again, it should be appreciated that any number of different incentives (e.g., rebates, discounts, dynamic pricing options, special offers, etc.) may be identified to the merchant affiliate 122 at 320. Then, upon identification of the incentives, the affiliate engine 130 responds with an incentive (or multiple incentives), at 322, to help entice the consumer 112 to perform a purchase transaction at the merchant 102. The response may be directed to the communication device 114 associated with the consumer 112 (such that the consumer directly receives the incentives). Or alternatively, (or additionally), the response may be directed to the communication device 126 associated with the merchant affiliate 122, whereupon the merchant affiliate 122 is able to then select the specific incentive to provide to the consumer 112 (upon which it is assigned and/or delivered to the consumer 112), etc.

When the consumer 112 desires to use one or more of the incentives provided by the affiliate engine 130 to purchase a product, he/she may select the product (and potentially the desired one or more incentives to be used) and perform a purchase transaction for the product as described above. In addition, the merchant affiliate 122 (and/or the merchant 102) may adopt the consumer 112 as a merchant affiliate. When the consumer 112 responds positively, the consumer 112 is then registered to the affiliate engine 130, whereupon the consumer 112 is becomes a merchant affiliate, as described herein (wherein and the affiliate engine 130 may add various merchant affiliate content to the merchant's profile in the merchant data structure 134 relating to the consumer 112). It should be appreciated that other merchant affiliates, in addition to merchant affiliate 122, may also be compensated and/or otherwise incentivized to recruit new merchant affiliates, thereby aiding in the growth and/or reach of the network of affiliates for the merchant 102.

Subsequently, the affiliate engine 130 detects, at 326, the redemption of the incentive(s) and imposes the appropriate compensation for the merchant affiliate 122, at 328 (e.g., as shown in Table 1, as retrieved from the merchant data structure 134, etc.). In connection therewith, the affiliate engine 130 also imposes compensation on the merchant affiliate 122 for recruiting the consumer 112 to agree to be a new affiliate (e.g., a 15% coupon for the merchant 102 (or another merchant) as shown in Table 1, etc.). Again, depending on the form of the compensation, the affiliate engine 130 may assign the compensation to the merchant affiliate 122 and fund an account associated with the merchant affiliate 122 with the compensation (e.g., a payment account associated with the merchant affiliate 122 at the merchant 102, etc.), immediately or at one or more intervals. Alternatively, the affiliate engine 130 may cause the compensation to be physically delivered to the merchant affiliate 122 at an address associated therewith.

In view of the above, the systems and methods herein may permit merchants to create networks of affiliates capable of reaching consumers outside of the merchants' traditional locations, for example, in social events, etc. In this manner, the merchants are potentially able to address the needs of more consumers to purchase products or obtain product support, through the merchant affiliates, without the consumers having to initiate the interactions. Further, the merchants, through the merchant affiliates, are able to reach consumers in settings that may be more comfortable to the consumers to facilitate interactions, and/or that may be more convenient to the consumers to present product incentives and/or product support.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) associating a reference biometric to a merchant, the reference biometric representative of a merchant affiliate associated with the merchant; (b) storing the reference biometric in a data structure as part of a merchant profile for the merchant; (c) receiving a request from a communication device associated with a consumer, the request involving the merchant and including a biometric captured by the communication device; (d) receiving an indication of a product from the communication device associated with the consumer, and facilitating a purchase transaction for the product; (e) searching in the data structure for the biometric included in the request; and (f) when the biometric included in the request matches the reference biometric representative of the merchant affiliate, responding to the request with an incentive for purchase of at least one product at the merchant.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in promoting consumer interaction with a merchant, through a merchant affiliate, the method comprising:
associating a reference biometric to a merchant, the reference biometric representative of a merchant affiliate associated with the merchant;
storing the reference biometric in a data structure as part of a merchant profile for the merchant;
receiving, at a computing device, a request from a communication device associated with a consumer, the request involving the merchant and including a biometric captured by the communication device;
searching in the data structure, by the computing device, for the biometric included in the request; and
when the biometric included in the request matches the reference biometric representative of the merchant affiliate, responding to the request, by the computing device, with an incentive for purchase of at least one product at the merchant.

2. The computer-implemented method of claim 1, wherein the merchant affiliate includes a merchant representative; and
wherein responding to the request includes approving at least one service at a communication device associated with the merchant representative.

3. The computer-implemented method of claim 2, wherein the at least one service includes at least one of a coupon distribution, consumer support for a product, a product description, and a sales commission for the merchant representative.

4. The computer-implemented method of claim 1, further comprising receiving, at the computing device, an indication of a product from the communication device associated with the consumer; and
wherein the incentive includes a coupon associated with the product and redeemable with the merchant.

5. The computer-implemented method of claim 4, further comprising facilitating, by the computing device, a purchase transaction for the product, based on the incentive.

6. The computer-implemented method of claim 5, further comprising receiving, by the computing device, from the communication device associated with the consumer, payment account credentials for a payment account to be used to fund the purchase transaction, the payment account associated with a virtual wallet at the communication device.

7. The computer-implemented method of claim 1, wherein the merchant affiliate is a prior consumer of the merchant; and
wherein responding to the request includes awarding the incentive to the prior consumer, in response to a purchase of at least one product at the merchant by the consumer.

8. The computer-implemented method of claim 7, wherein awarding the incentive to the prior consumer includes awarding the incentive or a different incentive to the prior consumer, in response to the consumer agreeing to become a new merchant affiliate of the merchant.

9. The computer-implemented method of claim 1, wherein the request includes a request for support regarding a product associated with the merchant; and
wherein responding to the request includes transmitting a support interface to the communication device associated with the consumer, whereby the consumer is able to submit one or more further details of the requested support.

10. The computer-implemented method of claim 9, further comprising generating a support ticket for the requested support, when the consumer and/or the merchant affiliate are unable to resolve the request, and transmitting the support ticket to a support entity associated with the merchant.

11. A system for use in promoting consumer interaction with merchants through merchant affiliates, the system comprising:
a memory including a data structure, the data structure including a merchant profile for a merchant, the merchant profile including a reference biometric relating to a merchant affiliate associated with the merchant and a compensation schedule assigned to the merchant affiliate; and
an affiliate engine coupled to the memory and configured to:
receive a request from a consumer regarding the merchant, the request including a biometric associated with the merchant affiliate;
confirm that the biometric from the request matches the reference biometric in the data structure in the memory; and
impose compensation to the merchant affiliate, based on the compensation schedule in the data structure in the memory, when the consumer redeems a coupon for a product at the merchant and/or when a support concern identified by the consumer in the request is resolved.

12. The system of claim 11, wherein, in connection with imposing compensation to the merchant affiliate, the affiliate engine is configured to impose the compensation to the merchant affiliate when the consumer redeems the coupon for the product at the merchant; and
wherein the affiliate engine is further configured to transmit the coupon to a communication device associated with the consumer, after confirming that the biometric from the request matches the reference biometric in the data structure in the memory.

13. The system of claim 12, wherein the merchant profile in the data structure in the memory further includes multiple coupons assigned to the merchant affiliate; and
wherein, in connection with transmitting the coupon to the communication device associated with the consumer, the affiliate engine is configured to retrieve the coupon from the multiple coupons in the data structure in the memory based on the request.

14. The system of claim 13, wherein the request includes an indication of a product; and
wherein, in connection with retrieving the coupon from the multiple coupons in the data structure in the memory, the affiliate engine is configured to retrieve the coupon based on the indication of the product in the request.

15. The system of claim 14, wherein the affiliate engine is further configured to generate an authorization request for a purchase transaction for the product, based on the coupon.

16. The system of claim 11, wherein the request includes a request for support regarding a support concern for a product associated with the merchant; and
wherein, in connection with imposing compensation to the merchant affiliate, the affiliate engine is configured to impose the compensation to the merchant affiliate when the request for support is resolved.

17. The system of claim 16, wherein, in response to receiving the request, the affiliate engine is further configured to transmit a support interface to the communication device associated with the merchant affiliate and/or the communication device associated with the consumer, whereby the consumer and/or the merchant affiliate are able to submit one or more further details of the requested support.

18. A non-transitory computer readable storage media including computer-executable instructions for use in promoting consumer interaction with a merchant, which when executed by a processor, cause the processor to:
receive a reference biometric for a merchant affiliate associated with a merchant and store the reference biometric in a merchant data structure in association with the merchant;
receive a request regarding merchant from a communication device associated with a consumer, the request including a biometric captured by the communication device; and
when the biometric included in the request matches the reference biometric for the merchant affiliate, retrieve an incentive from the data structure assigned to the merchant affiliate.

19. The non-transitory computer readable storage media of claim 18, wherein the incentive includes at least one of a coupon relating to a purchase transaction by the consumer at the merchant and compensation for the merchant affiliate.

20. The non-transitory computer readable storage media of claim 19, wherein the computer-executable instructions, when executed by the processor, further cause the processor to impose the compensation to the merchant affiliate, when the consumer redeems the coupon.
